(19) United States
(12) Patent Application Publication
(10) Pub. No.: US 2010/0124476 A1
(43) Pub. Date: May 20, 2010

(54) CYLINDER CART HAVING A RETENTION HOOK

(76) Inventor: Darryl Berlinger, Doylestown, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/614,676

(22) Filed: Nov. 9, 2009

Related U.S. Application Data
(60) Provisional application No. 61/114,664, filed on Nov. 14, 2008.

(51) Int. Cl. B62D 51/04; B62B 5/00; B62B 3/04; B62B 3/00; B62B 3/10

(52) U.S. Cl. 414/457

(57) ABSTRACT

A cart for carrying a cylinder containing a liquid or gas is disclosed, the cylinder having an anchor location, the cart including a frame including a body and a handle, wheels coupled to the frame for carrying the frame and the cylinder, a hook capable of engaging the anchor location of the cylinder to capture and retain the cylinder on the frame, an automatic actuator configured to move the hook into and out of engagement with the anchor location, and first and second safety switches that are configured to be engaged respectively by left and right hands of a user, the safety switches disabling the actuator if not engaged by both hands of the user.

### CROSS-REFERENCE TO RELATED APPLICATIONS

This application claims priority to provisional U.S. patent application Ser. No. 61/114,664, filed Nov. 14, 2008, the contents of which are incorporated herein by reference in their entirety.

### TECHNICAL FIELD

The present invention relates to a cylinder cart, particularly a cylinder cart that includes a retention hook.

### BACKGROUND

Manual carts for carrying cylinders such as dewars or other liquid or gas cylinders are well known in many industries. Typical cylinders can contain liquefied Oxygen, Nitrogen, Argon or other gases or gas mixtures. Typical handling of cylinders such as liquefied gas cylinders, tanks, and dewars has been achieved by manually capturing the cylinder onto a cart, manually retaining it in the cart (e.g., using a retention hook), and then manually propelling the cart.

Manually pushing or pulling a cart containing a heavy or unwieldy cylinder can lead to leg, back and shoulder injuries. The exposure to such injuries is compounded when the cart is pushed or pulled along a graded surface. In addition, manual carts require the user to manually manipulate a retention hook that retains the cylinder. However, the high weights of some cylinders (e.g., dewars) exposes the user's hands and fingers to serious injuries such as crushing or amputation.

It is desirable to develop a cylinder cart that has improved performance compared to the designs in the prior art.

### SUMMARY

A cart for carrying a cylinder containing a liquid or gas is disclosed, the cylinder having an anchor location, the cart including a frame including a body and a handle, wheels coupled to the frame for carrying the frame and the cylinder, a hook capable of engaging the anchor location of the cylinder to capture and retain the cylinder on the frame, an automatic actuator configured to move the hook into and out of engagement with the anchor location, and first and second safety switches that are configured to be engaged respectively by left and right hands of a user, the safety switches disabling the actuator if not engaged by both hands of the user.

A cart for carrying a cylinder containing a liquid or gas is disclosed, the cylinder having an anchor location, the cart including a frame including a body and a handle, wheels coupled to the frame for carrying the frame and the cylinder, a motor for driving the wheels, a hook capable of engaging the anchor location of the cylinder to capture and retain the cylinder on the frame, and a belly bar configured to directly contact the throttle when the belly bar is contacted, thereby reversing the of direction operation of the motor.

The cart can include a motor for driving the wheels. The cart can include a battery for powering the motor. The actuator can be an electro-mechanical actuator. The actuator can be one of a pneumatic cylinder or a hydraulic cylinder. The actuator can be linear such that the hook moves linearly upon actuation. The frame can include a lower platform extending from the body and capable of supporting an underside of the cylinder.

These and various other advantages and features are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there are illustrated and described preferred embodiments of the invention.

### BRIEF DESCRIPTION OF THE DRAWINGS

FIG. 1A is a side perspective view of a cylinder cart and cylinder illustrating aspects of the invention;

FIG. 1B is a rear perspective view of the cylinder cart and cylinder depicted in FIG. 1A;

FIG. 2A is a perspective view of the cylinder cart depicted in FIG. 1A;

FIG. 2B is a side view of the cylinder cart depicted in FIG. 2A;

FIG. 3A is a perspective view of a retention hook system included in the cylinder cart depicted in FIG. 2A; and

FIG. 3B is a perspective view of a control system included in the cylinder cart depicted in FIG. 2A.

### DETAILED DESCRIPTION OF ILLUSTRATIVE EMBODIMENTS

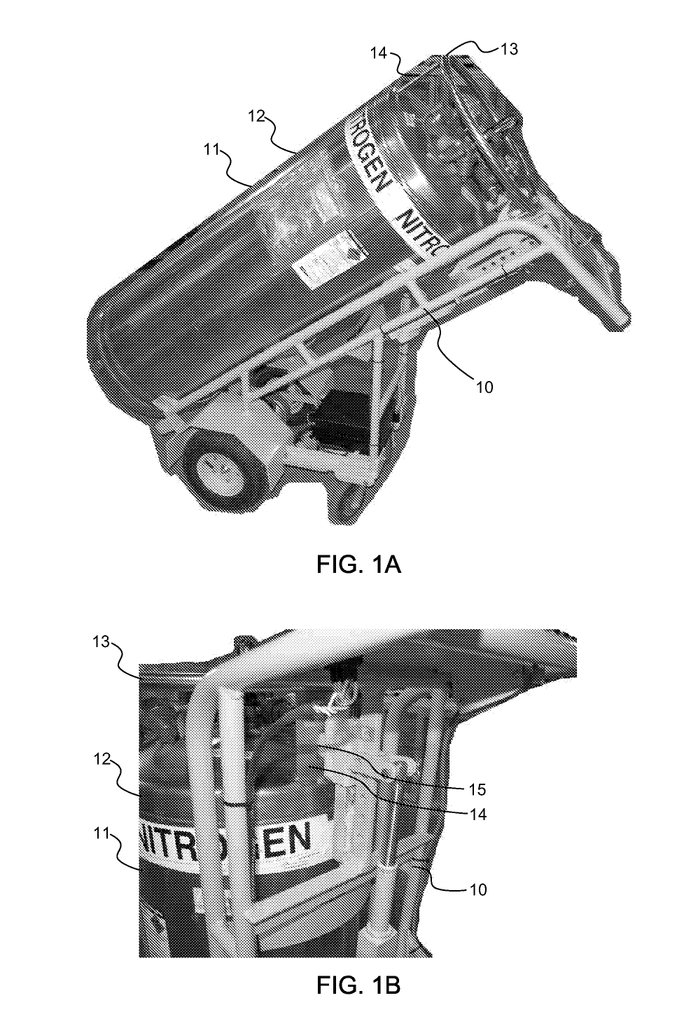

Referring to FIGS. 1A and 1B, an exemplary cylinder cart 10 is configured to carry a cylinder 11. The cylinder 11 includes a cylindrical body 12, a halo ring 13 mounted onto the upper end of the cylindrical body 12, and a plurality of connecting members 14 that connect the halo ring 13 to the cylindrical body 12. Each connecting member 14 includes an anchor slot 15.

The cylinder cart 10 preferably is configured to capture, retain, and move the cylinder 11, which can contain liquefied Oxygen, Nitrogen, Argon, or any other combinations of liquid or gas mixtures. For instance, the cylinder 11 can contain approximately 140 to 260 liters of a liquid that would be in a gas state at ambient temperature (e.g., 70° F.). The cylinder 11 can be of any size and shape as desired, such as approximately 20-26 inches in diameter, approximately 60 inches in height, and a weight of over 1,000 pounds in accordance with one embodiment.

The halo ring 13 can be a round structure disposed above the top surface of the cylindrical body 12. The halo ring 13 can substantially follow the outer perimeter of the cylindrical body 12 and can have substantially the same diameter as the cylindrical body 12. The halo ring 13 can also have a diameter smaller or greater than the outer perimeter of the cylindrical body 12. The halo ring 13 can share a common central axis with the cylindrical body 12. The halo ring 13 can also define a different central axis than the cylindrical body 12. The halo ring 13 can provide protection for various valves and fittings at the top of the cylinder 11. The halo ring 13 can provide a surface for a user to grab, so that the user can manually position the cylinder 11 by leaning or rolling the cylinder 11.

The halo ring 13 can be coupled to the cylinder 11 by one or more connecting members 14. As shown in FIG. 1B, each connecting member 14 can be welded or otherwise attached to the top of the cylinder 11 and the bottom of the halo ring 13. Each connecting member 14 can be provided as a vertical plate defining an anchor slot 15. Each anchor slot 15 can be configured to accommodate a conventional hook from a conventional manual cylinder cart.

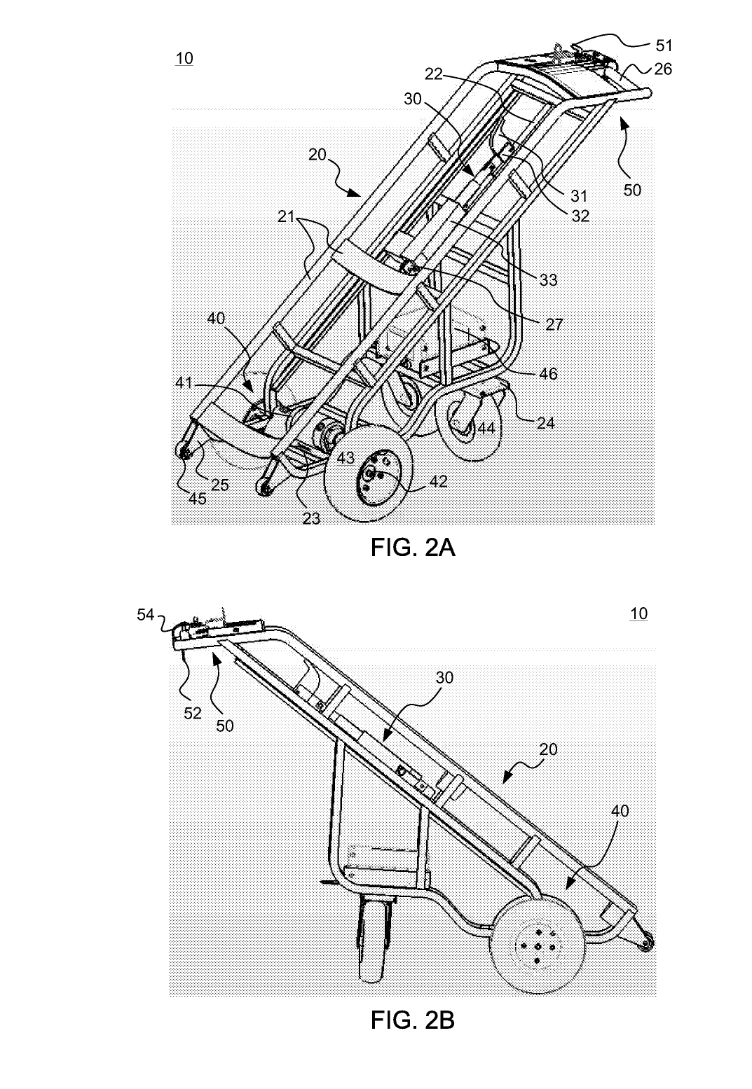

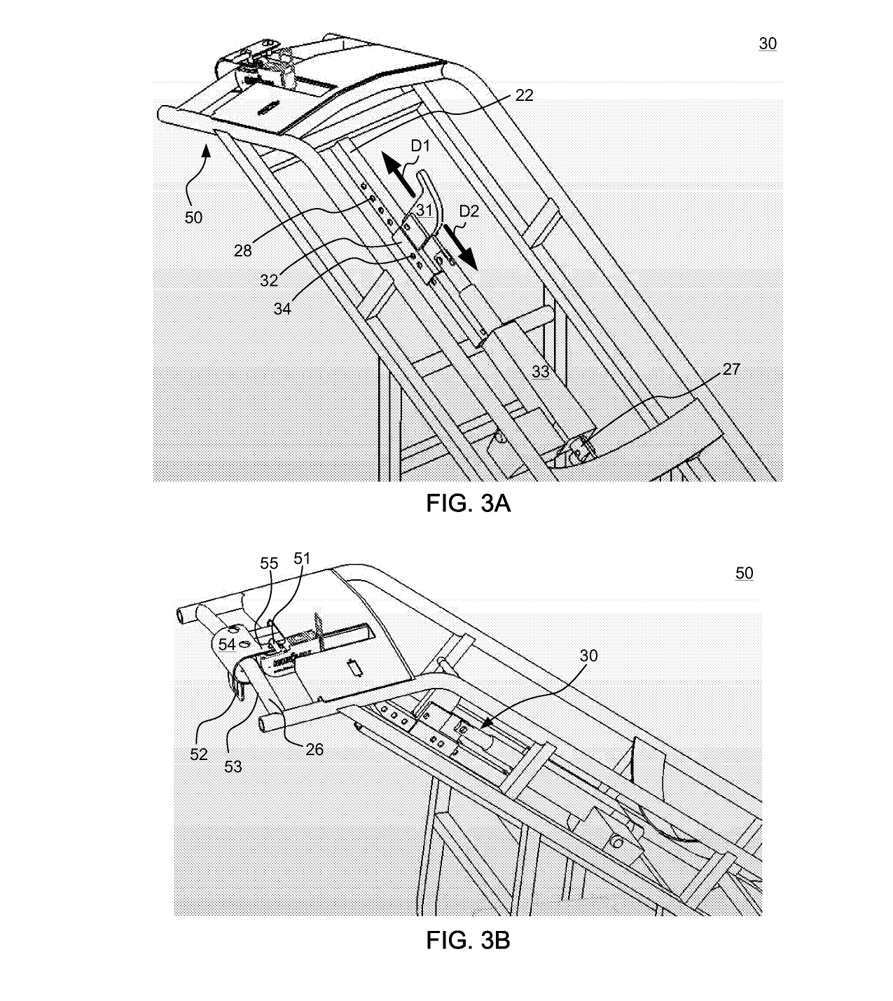

Referring now to FIGS. 2A and 2B, the cylinder cart 10 includes a frame 20, a retention hook system 30, a propulsion system 40, and a control system 50. The frame 20 includes cylinder support members (or frame body) 21, a hook support member 22, a motor support member 23, rear caster brackets 24, front wheel brackets 25, and handles 26. The hook support member 22 includes a hook actuator bracket 27 and adjustment holes 28 (shown in FIG. 3A). The retention hook system 30 includes a hook 31, a hook bracket 32, and a hook actuator 33. The hook bracket 32 includes positioning holes 34 (shown in FIG. 3A). The propulsion system 40 includes a motor 41, a drive wheel axle 42, drive wheels 43, rear wheels 44 (preferably rotatably mounted on the rear caster brackets 24 as caster wheels), front wheels 45, and a battery 46. The control system 50 includes a throttle 51, a hook control switch 52, handle tapes 53 (shown in FIG. 3B), a belly bar 54. The belly bar 54 includes a throttle contact portion 55 (shown in FIG. 3B).

The frame 20 can be made from steel or any other material known in the art that can support the weight of a typical cylinder 11. As shown in FIG. 2A, the cylinder support members 21 (and the hook 31) are configured to support the weight of a cylinder 11. The length and configuration of the cylinder support members 21 can be chosen to support a cylinder 11 of a desired range of sizes and diameters. In some embodiments (not shown), the frame 20 can include a lower platform (e.g., two toes or forks, a solid plate, or a plate of toes or forks) extending from the cylinder support members (or frame body) 21 and configured to support an underside of the cylinder 11. In some embodiments (not shown), the frame 20 can include one or more straps coupled to the cylinder support members 21 and configured to be placed around the outer perimeter of the cylindrical body 12 of the cylinder 11 such that the straps can help capture and/or retain the cylinder 11 against the frame 20.

The propulsion system 40 preferably assists a user in moving the cylinder cart 10 and the cylinder 11 forward and backward and on graded or ungraded surfaces. The propulsion system 40 can provide dynamic braking (not shown), which can allow a braking force to be applied to the drive wheels 43 when the forward or backward speed of the cylinder cart 10 exceeds a predetermined maximum safe speed. The propulsion system 40 can include an automatic parking brake (not shown) that can lock the drive wheels 43 when the motor 41 is not turning the drive wheels 43 (e.g., if the throttle 51 is at a zero-speed setting or if the motor 41 is not receiving power from the battery 46). The automatic parking brake feature can help prevent the cylinder cart 10 from unexpectedly rolling away from or towards the user. The battery 46 can provide energy to the motor 41. The battery 46 is preferably a 12-volt DC battery, but any battery, combination of batteries, or other power source for the motor 41 (and/or the hook actuator 33) can be used.

Referring now to FIG. 3A, the retention hook system 30 can allow a user to capture a cylinder, such as the cylinder 11, by automatically positioning the hook 31 into the anchor slot 15 or around a portion of the halo ring 13 and automatically raising the hook 31 upward in a direction D1 until the cylinder 11 is positioned on the cylinder cart 10. Although FIG. 1B shows the hook 31 positioned into the anchor slot 15, the hook 31 can also capture and retain the cylinder 11 by being positioned around a portion of the halo ring 13 or by being positioned into or around any structure known in the art that can allow the hook 31 to stably capture the cylinder 11 and retain the cylinder 11 against the cylinder cart 10. It can thus be appreciated that one or more surfaces defining the anchor slot 15, a portion of the halo ring 13, or any other suitable structure that is known in the art can serve as an anchor location for the hook 31 to capture and retain the cylinder 11. Anchor locations of any size, shape, and location that are coupled to the cylindrical body 12 are contemplated in the invention. Although the embodiment shown in the figures includes a motor 41 and a retention hook system 30, in other embodiments (not shown), the retention hook system 30 can be included in a cylinder cart 10 without a motor 41 (e.g., with a manual propulsion system).

As shown in FIG. 3A, the hook 31 preferably is removably coupled to the hook bracket 32. In some embodiments, the hook 31 can be integrally formed with the hook bracket 32. The hook 31 preferably is upward-pointing, such that the hook 31 can exert an upward force on the cylinder 11 when it is positioned in the anchor slot 15 or around a portion of the halo ring 13, thereby holding the cylinder 11 in position on the cylinder cart 10 while the cylinder 11 is being transported.

In embodiments where the hook 31 is removably coupled to the hook bracket 32, different hooks 31 having different lengths, shapes, or thicknesses can be coupled to the hook bracket 32, depending on the diameter of the cylinder 11, the weight of the cylinder 11, or the location or configuration of the anchor slot 15 or the halo ring 13. For example, the hook 31 can extend approximately two inches further from the hook support member 22 towards the cylinder 11 when a 26-inch diameter cylinder 11 is carried on the cylinder cart 10, compared to when a 20-inch diameter cylinder 11 is carried.

The hook actuator (or automatic actuator) 33 preferably is removably coupled to the hook bracket 32 and the actuator bracket 27 using, for example, ⅜-inch diameter pins (not shown). In some embodiments, the hook actuator 33 can be permanently attached or integrally formed with the hook bracket 32 and/or the actuator bracket 27, or any size pins or removable coupling mechanism can be used to couple the hook actuator 33 to the hook bracket 32 and the actuator bracket 27.

In embodiments where the hook actuator 33 is removable from the hook bracket 32 and the actuator bracket 27, when the hook actuator 33 is removed, the hook 31 can be manually positioned in the anchor slot 15 or around a portion of the halo ring 13, for example, as a back-up measure if the hook actuator 33 becomes inoperable. In such embodiments, as shown in FIG. 3A, the hook support member 22 includes a plurality of adjustment holes 28, and the hook bracket 32 includes positioning holes 34. Once the hook 31 is manually positioned in the anchor slot 15 or around a portion of the halo ring 13, a user can insert a pin through a pair of adjustment holes 28 and positioning holes 34 to fix the location of the hook bracket 32 in a particular desired position along the hook support member 22. In other embodiments, any locking mechanism that is known in the art can be used to fix the location of the hook bracket 32 in a particular desired position along the hook support member 22.

The adjustment holes 28 and the positioning holes 34 preferably are configured to accommodate a ⅜-inch pin, such that a single ⅜-inch pin can pass through a pair of adjustment holes 28 and positioning holes 34 to fix the location of the hook bracket 32 in a particular desired position along the hook support member 22. The adjustment holes 28 preferably are spaced at 1-inch intervals along the hook support member 22, although any size interval can be used. The positioning holes 34 preferably are spaced at ½-inch intervals along the hook bracket 32, although any size interval can be used.

As shown in FIG. 3A, the hook actuator (or automatic actuator) 33 preferably is an electromechanical screw-type device that is configured to slide the hook bracket 32 along the hook support member 22 in either an upward linear direction D1 or a downward linear direction D2. In other embodiments (not shown), the hook actuator 33 can be any positioning device that is known in the art, including, for example, an electromechanical actuator, a manual or automatic hydraulic cylinder, a manual or automatic pneumatic cylinder, a manual or motorized winch, a manual or motorized rack and pinion, or any other motorized or manual gearing or sprocket arrangement.

Although in FIG. 3A, the hook 31 and/or the hook bracket 32 is configured to move in a linear direction D1 or D2 along the linear hook support member 22, in other embodiments (not shown) the hook 31 can be configured to move in a non-linear direction along a non-linear hook support member 22. In some embodiments, for example, the hook 31 can move in an arcuate path towards and/or away from the anchor slot 15 or a portion of the halo ring 13.

In the embodiment shown in FIG. 3A, the hook actuator 33 receives energy from the battery 46. However, in other embodiments (not shown), any battery or other power source for the hook actuator 33 can be used. In some embodiments where the hook actuator 33 is mechanical, pneumatic, or hydraulic (not shown), the hook actuator 33 may not need to use a battery 46 or other power source.

Referring now to FIGS. 3A and 3B, the control system 50 allows a user to capture the cylinder 11 by automatically positioning the hook 31 without the user placing his hands on or near the retention hook system 30, particularly without the user placing his hands on or near the hook 31.

For instance, a user can control the propulsion system 40 by actuating the throttle 51, which can be located near the handles 26 such that the user can actuate the throttle 51 with a thumb while not removing either hand from the handles 26. The throttle 51 preferably provides an automatic safety feature that biases the throttle to return to the zero-speed position if the user's thumb or other finger is removed from the throttle 51.

As shown in FIG. 3B, the belly bar 54 preferably can protect a user by forcing the throttle 51 into a forward position if the belly bar 54 is contacted, for example, by the torso of a user who may be trapped between the belly bar 54 and a wall or other obstacle (not shown). If a user inadvertently moves the cylinder cart 10 backward towards a wall or other obstacle, thereby pinning the user between the handles 26 and the wall, the trapped portion of the user's body (e.g., the torso) can contact and actuate the belly bar 54. Upon actuation of the belly bar 54, the throttle contact portion 55 of the belly bar 54 pushes the throttle 51 into a forward position, which can cause the propulsion system 40 to move the cylinder cart 10 forward, away from the user and away from the wall or other obstacle. Although the throttle contact portion 55 is shown in FIG. 3B as integrally formed with the belly bar 54, in other embodiments (not shown), the throttle contact portion 55 can be separated from the belly bar 54, and the throttle contact portion 55 can instead be mechanically linked to the belly bar 54.

The control system 50 preferably includes two handle tapes (or safety switches) 53, each handle tape 53 preferably located on a respective handle 26. Each handle tape 53 can be a contact sensor or any other safety switch that is known in the art, such that the hook 31 and/or the drive wheels 43 can only move (via actuation of the hook control switch 52 and/or the throttle 51, respectively) when both hands are contacting the respective handle tape 53. In some embodiments, the handle tapes 53 can serve as a safety feature to ensure that the user can only operate the retention hook system 30 and the propulsion system 40 when the user's hands are safely positioned on the handles 26, thereby protecting the user's hands from injury. In some embodiments, the handle tapes 53 can disable the hook actuator 33 if both handle tapes 53 are not each engaged by respective left and right hands of a user.

A user preferably can control the retention hook system 30 by actuating the hook control switch 52, which preferably is located near the handles 26 such that the user can actuate the control switch 52 with a thumb while not removing either hand from the handles 26. For example, in some embodiments, the hook control switch 52 can be configured such that a user can slide the hook 31 in an upward direction D1 along the hook support member 22 by toggling or actuating the hook control switch 52 in an upward direction, and a user can slide the hook 31 in a downward direction D2 along the hook support member 22 by toggling or actuating the hook control switch 52 in a downward direction.

As shown in FIG. 3B, the hook control switch 52 preferably is located remotely from the retention hook system 30. This remote location of the hook control switch 52 relative to the retention hook system 30 can allow a user to capture and release a cylinder 11 without having to manually hold and position the hook 31. The automatic retention hook system 30 can be controlled by a user with the user's hands and fingers located remote from the hook 31 and the engagement area of the hook 31 and the anchor slot 15, which can eliminate or reduce the risk of injury to the user's hands during operation of the cylinder cart 10.

In the embodiment shown in FIG. 3B, the hook control switch 52 can be a mechanical toggle switch that is configured to send an electric signal to actuate the hook actuator 33. However, in other embodiments (not shown), the hook control switch 52 can be any switch, lever, crank, winch, pulley system, or any other mechanism that is known in the art that can move the hook 31 up and down, preferably without the user having to manually hold and position the retention hook system 30, particularly without the user having to manually hold and position the hook 31. The hook 31 preferably is positioned indirectly and/or remotely by the user actuating the hook control switch 52, not by grasping the hook 31 with the user's hands.

To capture a cylinder 11, a user can push the cylinder cart 10 toward a cylinder 11 to be captured. When the user can observe the approximate position of the anchor slot 15 and/or the halo ring 13, the user can actuate the control switch 52 to move the hook 31 to an approximately aligned position with the anchor slot 15, for example. When the cylinder cart 10 is proximate to the cylinder 11, the user can rotate the cylinder cart 10 about the drive wheels 43 by pushing up on the handles 26 until the front wheels 45 contact the ground. While keeping both hands on the handles 26, the user can guide the hook 31 into the anchor slot 15. Once the hook 31 has been inserted into the anchor slot 15, the user can toggle the control switch 52 to move the hook 31 in an upward direction D1, preferably continuing to move the hook 31 in the upward direction D1 until the hook 31 has tightly engaged the anchor slot 15, thereby capturing the cylinder 11. Alternatively, a sensor (not shown) can be provided that causes the hook 31 to stop moving in the upward direction D1 when the hook 31 has tightly engaged the anchor slot 15, for example, such that the hook 31 has reached a predetermined location, is bearing a predetermined amount of weight, or has satisfied any other indication that identifies that the hook 31 has reached a location sufficient to capture and/or retain the cylinder 11. Once the cylinder 11 has been captured, the user can rotate the cylinder cart 10 about the drive wheels 43 by easing the handles 26 down until the rear wheels 44 contact the ground.

To release a cylinder 11, a user can rotate the cylinder cart 10 about the drive wheels 43 by pushing up on the handles 26 until the front wheels 45 contact the ground, and the user can continue to tilt the cylinder 11 forward until it is vertically oriented on the ground. While keeping both hands on the handles 26, the user can toggle the control switch 52 to move the hook 31 in a downward direction D2, until the hook 31 begins to disengage from the anchor slot 15. As the hook 31 disengages from the anchor slot 15, the user can rotate the cylinder cart 10 about the drive wheels 43 by easing the handles 26 down. Once the hook 31 is fully disengaged from the anchor slot 15, the user can continue to rotate the cylinder cart 10 about the drive wheels 43 until the rear wheels 44 contact the ground.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. The disclosed cylinder cart may address some or all of the problems previously described. A particular embodiment need not address all of the problems described, and the claimed cylinder cart should not be limited to embodiments comprising solutions to all of these problems. Further, several advantages have been described that flow from the structure and methods; the present invention is not limited to structure and methods that encompass any or all of these advantages. Those skilled in the relevant art, having the benefit of the teachings of this specification, may effect numerous modifications to the invention as described herein, and changes can be made without departing from the scope and spirit of the invention as defined by the appended claims. Furthermore, any features of one described embodiment can be applicable to the other embodiments described herein.

What is claimed:

1. A cart for carrying a cylinder containing a liquid or gas, the cylinder having an anchor location, the cart comprising:
a frame including a body and a handle;
wheels coupled to the frame for carrying the frame and the cylinder;
a hook capable of engaging the anchor location of the cylinder to capture and retain the cylinder on the frame;
an automatic actuator configured to move the hook into and out of engagement with the anchor location; and
first and second safety switches that are configured to be engaged respectively by left and right hands of a user, the safety switches disabling the actuator if not engaged by both hands of the user.

2. The cart of claim 1, further comprising a motor for driving the wheels.

3. The cart of claim 2, further comprising a battery for powering the motor.

4. The cart of claim 2, further comprising a belly bar configured to reverse the direction of operation of the motor when the belly bar is contacted.

5. The cart of claim 1, wherein the actuator is an electro-mechanical actuator.

6. The cart of claim 1, wherein the actuator is one of a pneumatic cylinder or a hydraulic cylinder.

7. The cart of claim 1, wherein the actuator is linear such that the hook moves linearly upon actuation.

8. A cart for carrying a cylinder containing a liquid or gas, the cylinder having an anchor location, the cart comprising:
a frame including a body and a handle;
wheels coupled to the frame for carrying the frame and the cylinder;
a motor for driving the wheels;
a hook capable of engaging the anchor location of the cylinder to capture and retain the cylinder on the frame; and
a belly bar configured to directly contact the throttle when the belly bar is contacted, thereby reversing the of direction operation of the motor.
